(19) United States
(12) Patent Application Publication
(10) Pub. No.: US 2025/0155618 A1
(43) Pub. Date: May 15, 2025

(54) LIGHT GUIDE PLATE AND IMAGE DISPLAY DEVICE

(71) Applicant: SONY GROUP CORPORATION, TOKYO (JP)

(72) Inventor: KAZUE SHIMIZU, TOKYO (JP)

(21) Appl. No.: 18/839,133

(22) PCT Filed: Jan. 18, 2023
(86) PCT No.: PCT/JP2023/001241

§ 371 Date: Aug. 16, 2024

(30) Foreign Application Priority Data
Feb. 25, 2022 (JP) 2022-028501

(51) Int. Cl. G02B 5/18; G02B 6/34; G02B 27/01

(52) U.S. Cl. CPC G02B 5/1823; G02B 6/34; G02B 27/0172

(57) ABSTRACT

To improve image quality by increasing light use efficiency and the like. Provided is a light guide plate including an incidence diffraction grating that diffracts incident light into the light guide plate, a substrate that internally and totally reflects the light diffracted into the light guide plate by the incidence diffraction grating and guides the light, an expansion diffraction grating that diffracts and expands the light guided by the substrate, and an emission diffraction grating that diffracts the light diffracted by the expansion diffraction grating and projects the light into the pupils of an observer, wherein the expansion diffraction grating includes at least two regions that are a first region and a second region in front view, the sum of a grating vector provided for the incidence diffraction grating, a grating vector provided for the expansion diffraction grating, and a basic grating vector provided for the emission diffraction grating is 0, and the grating vector of the diffraction grating having the highest diffraction efficiency among the diffraction gratings provided for the first region is provided in a different direction from the grating vector of the diffraction grating having the highest diffraction efficiency among the diffraction gratings provided for the second region.

### TECHNICAL FIELD

The present technique relates to a light guide plate and an image display device.

### BACKGROUND ART

Conventionally, light guide plates for projecting image light into observer's eyes have been developed to achieve extended reality (XR) including augmented reality (AR), virtual reality (VR), and mixed reality (MR).

For example, PTLs 1 to 3 disclose techniques relating to light guide plates that improve image quality by increasing light use efficiency and the like.

### CITATION LIST

### Patent Literatures

### [PTL 1]

U.S. Patent Application Publication No. 2018/0210205

### [PTL 2]

WO 2020/217044

### [PTL 3]

U.S. Patent Application Publication No. 2021/0311260

### SUMMARY

### Technical Problem

However, the techniques disclosed in PTLs 1 to 3 are susceptible to improvement in light use efficiency and the like.

Thus, a primary object of the present technique is to provide a light guide plate and an image display device that improve image quality by increasing light use efficiency and the like.

### Solution to Problem

The present technique provides a light guide plate including an incidence diffraction grating that diffracts incident light into the light guide plate, a substrate that internally and totally reflects the light diffracted into the light guide plate by the incidence diffraction grating and guides the light, an expansion diffraction grating that diffracts and expands the light guided by the substrate, and an emission diffraction grating that diffracts the light diffracted by the expansion diffraction grating and projects the light into the pupils of an observer, wherein the expansion diffraction grating includes at least two regions that are a first region and a second region in front view, the sum of a grating vector provided for the incidence diffraction grating, a grating vector provided for the expansion diffraction grating, and a basic grating vector provided for the emission diffraction grating is 0, and the grating vector of the diffraction grating having the highest diffraction efficiency among the diffraction gratings provided for the first region is provided in a different direction from the grating vector of the diffraction grating having the highest diffraction efficiency among the diffraction gratings provided for the second region. The light guide plate may further include a first diffraction grating and a second diffraction grating that are at least two diffraction gratings opposed to each other with the expansion diffraction grating interposed therebetween in front view, the diffraction gratings diffracting, to the emission diffraction grating, the light diffracted by the expansion diffraction grating, wherein the pitch and the direction of the expansion diffraction grating may be substantially identical to the pitches and the directions of the first diffraction grating and the second diffraction grating. The first region and the second diffraction grating may be adjacent to each other in front view, and the second region and the first diffraction grating may be adjacent to each other in front view.

The first region and the first diffraction grating may be disposed on one surface of the substrate, and the second region and the second diffraction grating may be disposed on the other surface of the substrate.

The first region and the second region may be disposed on one surface of the substrate, and the first diffraction grating and the second diffraction grating may be disposed on the other surface of the substrate.

The first region, the second region, the first diffraction grating, and the second diffraction grating may be disposed on one surface of the substrate.

In front view, a clearance may be formed at least in a part of the incidence diffraction grating between the first region and the second region, and the clearance may be formed substantially at the center of the divergence of a pencil of light emitted from the incidence diffraction grating to the expansion diffraction grating. In front view, a third region may be formed to overlap with at least parts of the first region and the second region at the emission diffraction grating side, and the third may be formed substantially at the center of the divergence of a pencil of light emitted from the incidence diffraction grating to the expansion diffraction grating. The third region may have a two-dimensional periodic structure.

The light guide plate may further include a return diffraction grating that diffracts the light in an inward direction of the emission diffraction grating. The return diffraction grating may be disposed outside a region where light is incident from the substrate and may be disposed at outer periphery of the emission diffraction grating.

The size of a grating vector provided for the return diffraction grating is substantially twice the size of the basic grating vector.

The grating vector provided for the return diffraction grating may be substantially identical to a vector connecting the initial points of the basic grating vectors. The return diffraction grating may have a one-dimensional or two-dimensional periodic structure.

The light guide plate may further include a third diffraction grating between the first region and the first diffraction grating, the third diffraction grating being adjacent to the first region and having lower diffraction efficiency than the first region at a diffraction order for emitting light out of the light guide plate. The pitch and the direction of the diffraction grating provided for the first region may be substantially identical to the pitch and the direction of the diffraction gratings provided for the third diffraction grating.

The light guide plate may further include a region that is adjacent to the first region and has a substantially flat entry face for the light between the first region and the first diffraction grating.

Diffraction gratings provided for the expansion diffraction grating may be placed in a two-dimensional array, and among the pitches of the diffraction gratings provided for the expansion diffraction grating, the pitch of a diffraction order for the highest diffraction efficiency may be substantially equal to the pitch of the first diffraction grating or the second diffraction grating.

The grating vector provided for the first diffraction grating may be a vector connecting the terminal point of the grating vector of the diffraction grating having the highest diffraction efficiency among diffraction gratings provided for the first region and the terminal point of the grating vector of the diffraction grating having the highest diffraction efficiency among diffraction gratings provided for the second region.

The emission diffraction grating may be disposed at the same position or a different position with respect to the incidence diffraction grating in the thickness direction of the light guide plate.

The light guide plate may include the one or more incidence diffraction gratings and the one or more emission diffraction gratings.

Furthermore, the present technique provides an image display device including the light guide plate and an image forming unit that projects image light onto the light guide plate.

The present technique can provide a light guide plate and an image display device that improve image quality by increasing light use efficiency and the like. The effects described here are not necessarily limited and any of the effects described in the present disclosure may be implemented.

### BRIEF DESCRIPTION OF DRAWINGS

FIG. 1 is a schematic front view illustrating a configuration example of a light guide plate 1 according to an embodiment of the present technique.

FIG. 2 is a schematic side view illustrating the configuration example of the light guide plate 1 according to the embodiment of the present technique.

FIG. 3 is a schematic front view illustrating a configuration example of a light guide plate 1 according to an embodiment of the present technique.

FIG. 4 shows wave number space coordinates indicating a design example of diffraction gratings according to the embodiment of the present technique.

FIG. 5 is a schematic front view illustrating a configuration example of the light guide plate 1 according to the embodiment of the present technique.

FIG. 6 shows light intensity distribution charts indicating simulation results on the use of the light guide plate 1 according to the embodiment of the present technique.

FIG. 7 is a schematic front view illustrating a configuration example of the light guide plate 1 according to the embodiment of the present technique.

FIG. 8 is a schematic side view illustrating the configuration example of the light guide plate 1 according to the embodiment of the present technique.

FIG. 9 is a schematic front view illustrating a configuration example of the light guide plate 1 according to the embodiment of the present technique.

FIG. 10 shows light intensity distribution charts indicating simulation results on the use of the light guide plate 1 according to the embodiment of the present technique.

FIG. 11 is a schematic front view illustrating a configuration example of a light guide plate 1 according to an embodiment of the present technique.

FIG. 12 shows wave number space coordinates indicating the design example of diffraction gratings according to the embodiment of the present technique.

FIG. 13 is a schematic front view illustrating a configuration example of a light guide plate 1 according to an embodiment of the present technique.

FIG. 14 is a schematic front view illustrating a configuration example of a light guide plate 1 according to an embodiment of the present technique.

FIG. 15 illustrates a diffraction grating configuration example around the boundary between a second region 52 and a first diffraction grating 61 according to the embodiment of the present technique.

FIG. 16 schematically illustrates a configuration example of diffraction gratings according to an embodiment of the present technique.

FIG. 17 schematically illustrates a configuration example of the diffraction gratings according to the embodiment of the present technique.

FIG. 18 schematically illustrates a configuration example of diffraction gratings according to an embodiment of the present technique.

FIG. 19 schematically illustrates a configuration example of the diffraction gratings according to the embodiment of the present technique.

FIG. 20 schematically illustrates a configuration example of diffraction gratings according to an embodiment of the present technique.

FIG. 21 is a schematic front view illustrating a configuration example of a light guide plate 1 according to an embodiment of the present technique.

FIG. 22 shows wave number space coordinates indicating a design example of diffraction gratings according to the embodiment of the present technique.

FIG. 23 is a schematic front view illustrating a configuration example of a light guide plate 1 according to an embodiment of the present technique.

FIG. 24 shows wave number space coordinates indicating a design example of diffraction gratings according to the embodiment of the present technique.

FIG. 25 is a schematic side cross-sectional view illustrating a configuration example of a light guide plate 1 according to an embodiment of the present technique.

FIG. 26 is a schematic side cross-sectional view illustrating a configuration example of a light guide plate 1 according to an embodiment of the present technique.

FIG. 27 is a block diagram illustrating a configuration example of an image display device 10 according to an embodiment of the present technique.

FIG. 28 is a schematic front view illustrating a configuration example as a comparative example of a light guide plate 1 according to the embodiment of the present technique.

FIG. 29 is a schematic side view illustrating the configuration example as a comparative example of the light guide plate 1 according to the embodiment of the present technique.

FIG. 30 shows wave number space coordinates indicating a design example of diffraction gratings according to the embodiment of the present technique.

FIG. 31 is a schematic front view illustrating a comparative example of the light guide plate 1 according to the embodiment of the present technique.

### DESCRIPTION OF EMBODIMENTS

Preferred embodiments for implementing the present technique will be described below with reference to the accompanying drawings. The embodiments described below illustrate examples of a representative embodiment of the present technique and do not limit the scope of the present technique. Alternatively, the present technique can be implemented by a combination of any ones of examples described below and modification thereof.

In the descriptions of the embodiments below, the configurations may be described with terms including “substantially,” for example, “substantially parallel” or “substantially orthogonal.” For example, “substantially parallel” means perfect parallelism and a substantially parallel state, that is, a state of shift by, for example, about several percents from a perfect parallel state. The same applies to other terms with “substantially”. Furthermore, the drawings are schematically shown and are not necessarily exact illustrations.

In the drawings, unless otherwise specified, “up” means the upward direction or the upper side in the drawing, “down” means the downward direction or the lower side in the drawing, “left” means the leftward direction or the left side in the drawing, and “right” means the rightward direction or the right side in the drawing. Moreover, the same or equivalent elements or members in the drawings are denoted by the same reference numerals, and redundant descriptions thereof are omitted.

Descriptions will be given in the following order.
1. First Embodiment (Example 1 of Light Guide Plate)
2. Second Embodiment (Example 2 of Light Guide Plate)
(1) Configuration
(2) Grating Vector
(3) Effects
(4) Configuration of Expansion Diffraction Grating, etc.
(5) Simulation Results
(6) Comparison with Conventional Art
3. Third Embodiment (Example 3 of Light Guide Plate)
4. Fourth Embodiment (Example 4 of Light Guide Plate)
5. Fifth Embodiment (Example 5 of Light Guide Plate)
6. Sixth Embodiment (Example 6 of Light Guide Plate)
7. Seventh Embodiment (Example 7 of Light Guide Plate)
8. Eighth Embodiment (Example 8 of Light Guide Plate)
9. Ninth Embodiment (Example 9 of Light Guide Plate)
10. Tenth Embodiment (Example 10 of Light Guide Plate)
11. Eleventh Embodiment (Example 11 of Light Guide Plate)
12. Twelfth Embodiment (Example 12 of Light Guide Plate)
13. Thirteenth Embodiment (Example of Image Display Device)

### 1. First Embodiment (Example 1 of Light Guide Plate)

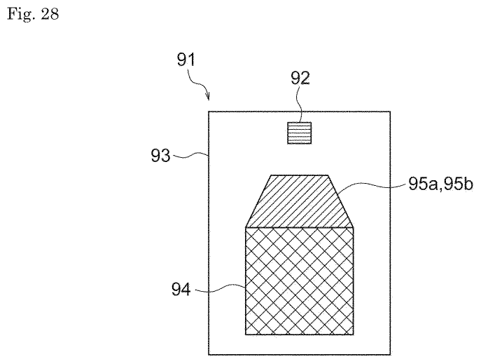

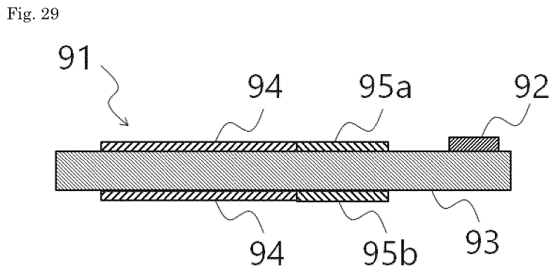

In the conventional art, unfortunately, light use efficiency is reduced when light to be guided into a light guide plate is emitted out of the light guide plate. Referring to FIGS. 28 and 29, this problem will be described below. FIG. 28 is a schematic front view illustrating a configuration example as a comparative example of a light guide plate 1 according to an embodiment of the present technique. FIG. 29 is a schematic side view illustrating a configuration example as a comparative example of the light guide plate 1 according to an embodiment of the present technique.

As illustrated in FIGS. 28 and 29, a light guide plate 91 as a comparative example includes an incidence diffraction grating 92, a substrate 93, expansion diffraction gratings 95a and 95b, and emission diffraction gratings 94. The incidence diffraction grating 92 diffracts parallel rays, which are projected from an image forming unit (not illustrated) for forming image light, into the light guide plate. The substrate 93 internally and totally reflects light diffracted into the light guide plate 91 by the incidence diffraction grating 92 and guides the light. The expansion diffraction gratings 95a and 95b diffract and expand the light guided by the substrate 93. The expansion diffraction grating 95a is disposed on one surface of the substrate 93. The expansion diffraction grating 95b is disposed on the other surface of the substrate 93. The emission diffraction gratings 94 diffract the light diffracted by the expansion diffraction gratings and project the light into the pupils of an observer. Thus, light at each image height from the image forming unit is projected into the pupils of the observer. Consequently, the observer can visually identify, as a virtual image, an image generated by the image forming unit.

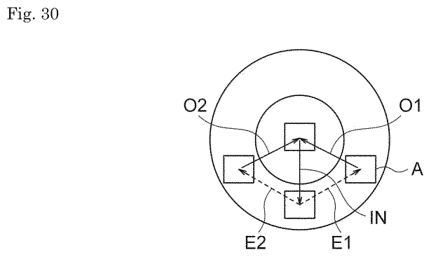

Referring to FIG. 30, a design example of the diffraction gratings will be described below. FIG. 30 shows wave number space coordinates indicating the design example of the diffraction gratings according to an embodiment of the present technique. As shown in FIG. 30, grating vectors IN, E1, E2, O1, and O2 and field angle areas A are indicated.

The grating vector IN indicates a grating vector provided for the incidence diffraction grating 92 for collecting incident light into the light guide plate 1. The grating vector E1 indicates a grating vector provided for the expansion diffraction grating 95a for extending pupils in a lateral direction in front view in FIG. 28 with respect to the axis of light projected into the light guide plate 1 from the incidence diffraction grating 92. The grating vector E2 indicates a grating vector provided for the expansion diffraction grating 95b for extending pupils in a lateral direction in front view in FIG. 28 with respect to the axis of light projected into the light guide plate 1 from the incidence diffraction grating 92. The basic grating vectors O1 and O2 indicate basic grating vectors provided for the emission diffraction grating 4 for externally expanding light collected into the light guide plate 1 and projecting light into the pupils of an observer.

In this design example, the grating vectors IN, E1, and O1 substantially constitute an isosceles triangle. Likewise, the grating vectors IN, E2, and O2 substantially constitute an isosceles triangle. The sum of the grating vector IN for the incidence diffraction grating 2, the grating vector E1 for the expansion diffraction grating 95a, and the basic grating vector O1 for the emission diffraction grating 4 is 0. Likewise, the sum of the grating vector IN for the incidence diffraction grating 2, the grating vector E2 for the expansion diffraction grating 95b, and the basic grating vector O2 for the emission diffraction grating 4 is 0. This can suppress a deterioration of image quality. The image quality deteriorates as a difference increases.

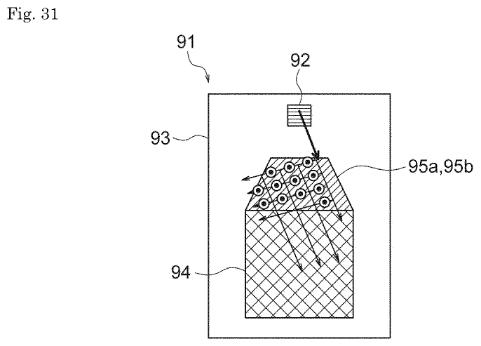

The vectors of the grating vectors E1 and E2 and the basic grating vectors O1 and O2 are present on the front and back sides of the substrate 93. The grating vector E1 and the basic grating vector O2 are substantially identical in vector configuration. The grating vector E2 and the basic grating vector O1 are substantially identical in vector configuration. Specifically, the expansion diffraction gratings 95a and 95b have the function of extending pupils in a lateral direction in front view in FIG. 28 with respect to the axis of light projected into the light guide plate 1 from the incidence diffraction grating 92, and the expansion diffraction gratings 95a and 95b also have the function of emitting light out of the light guide plate 91. Hence, light projected to the expansion diffraction gratings 95a and 95b is partially emitted out of the light guide plate 91, thereby reducing light use efficiency. Referring to FIG. 31, this problem will be described below. FIG. 31 is a schematic front view illustrating a comparative example of the light guide plate 1 according to an embodiment of the present technique.

As illustrated in FIG. 31, light from the incidence diffraction grating 92 is projected onto the expansion diffraction gratings 95a and 95b. The expansion diffraction gratings 95a and 95b have the function of extending pupils in a lateral direction in front view in FIG. 28 with respect to the axis of light projected into the light guide plate 1 from the incidence diffraction grating 92, and the expansion diffraction gratings 95a and 95b emit light in a direction to the outside of the light guide plate 1 (a direction from the far side to the near side in the drawing). Thus, light is lost and the light use efficiency decreases. Consequently, the image quality deteriorates.

In order to solve the problem, the present technique provides a light guide plate including an incidence diffraction grating that diffracts incident light into the light guide plate, a substrate that internally and totally reflects the light diffracted into the light guide plate by the incidence diffraction grating and guides the light, an expansion diffraction grating that diffracts and expands the light guided by the substrate, and an emission diffraction grating that diffracts the light diffracted by the expansion diffraction grating and projects the light into the pupils of an observer, wherein the expansion diffraction grating includes at least two regions that are a first region and a second region in front view, the sum of a grating vector provided for the incidence diffraction grating, a grating vector provided for the expansion diffraction grating, and a basic grating vector provided for the emission diffraction grating is 0, and the grating vector of the diffraction grating having the highest diffraction efficiency among the diffraction gratings provided for the first region is provided in a different direction from the grating vector of the diffraction grating having the highest diffraction efficiency among the diffraction gratings provided for the second region.

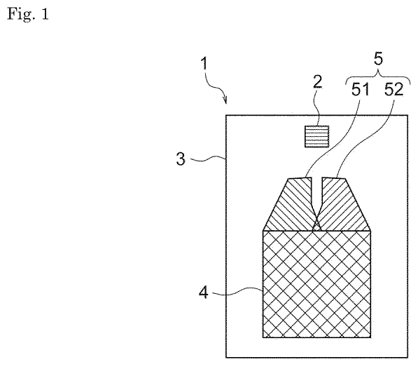

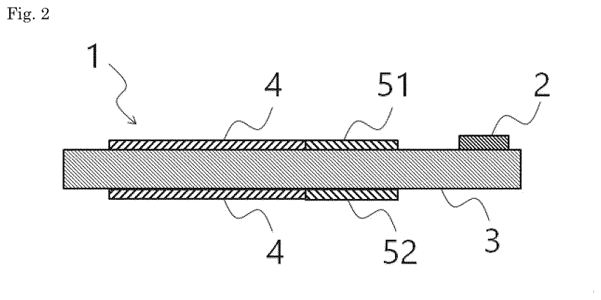

Referring to FIGS. 1 and 2, a configuration example of a light guide plate according to an embodiment of the present technique will be described below. FIG. 1 is a schematic front view illustrating a configuration example of the light guide plate 1 according to the embodiment of the present technique. FIG. 2 is a schematic side view illustrating the configuration example of the light guide plate 1 according to the embodiment of the present technique.

As illustrated in FIG. 1, the light guide plate 1 includes an incidence diffraction grating 2, a substrate 3, an expansion diffraction grating 5, and an emission diffraction grating 4. For example, a surface relief grating (SRG) or a volume phase holographic grating (VPHG) can be used as the incidence diffraction grating 2, the expansion diffraction grating 5, and the emission diffraction grating 4. If a volume phase holographic grating is used, a plurality of diffraction gratings may be formed on the same surface or a plurality of diffraction gratings may be configured as a laminate. Hereinafter, a surface relief grating will be described as an example of the incidence diffraction grating 2, the expansion diffraction grating 5, and the emission diffraction grating 4.

The incidence diffraction grating 2 diffracts substantially parallel rays, which are projected from an image forming unit (not illustrated) for forming image light, into the light guide plate. The substrate 3 internally and totally reflects light diffracted into the light guide plate 1 by the incidence diffraction grating 2 and guides the light. The expansion diffraction grating 5 diffracts and expands the light guided by the substrate 3. The emission diffraction grating 4 diffracts the light diffracted by the expansion diffraction grating 5 and projects the light into the pupils of an observer. Thus, light at each image height from the image forming unit is projected as substantially parallel rays into the pupils of the observer. Consequently, the observer can visually identify, as a virtual image, an image generated by the image forming unit.

The expansion diffraction grating 5 has at least two regions: a first region 51 and a second region 52 in front view. In FIG. 1, it appears that the first region 51 and the second region 52 are disposed on the same surface. In reality, the first region 51 and the second region 52 are disposed on different surfaces as illustrated in FIG. 2. The first region 51 is disposed on one surface of the substrate 3. The second region 52 is disposed on the other surface of the substrate 3. In the drawing, the emission diffraction grating 4 is disposed on each surface of the substrate 3. The emission diffraction grating 4 may be disposed only on one surface of the substrate 3.

Each of the first region 51 and the second region 52 has a banded one-dimensional periodic structure (e.g., a binary shape). Thus, each of the first region 51 and the second region 52 can diffract light from the incidence diffraction grating 2 in a specific direction.

Referring to FIG. 30 again, a design example of the diffraction gratings will be described below. The grating vector IN indicates a grating vector provided for the incidence diffraction grating 2. The grating vector E1 indicates the grating vector of the diffraction grating having the highest diffraction efficiency among the diffraction gratings provided for the first region 51. For example, when the first region 51 includes a two-dimensional diffraction grating, the first region 51 includes a plurality of grating vectors. The grating vector E1 is the grating vector of the diffraction grating having the highest diffraction efficiency among the plurality of diffraction gratings. Moreover, when the first region 51 includes a one-dimensional diffraction grating, the first region 51 includes one grating vector. Likewise, the grating vector E2 indicates the grating vector of the diffraction grating having the highest diffraction efficiency among the diffraction gratings provide for the second region 52. The basic grating vectors O1 and O2 indicate basic grating vectors provided for the emission diffraction grating 4.

In this design example, the grating vectors IN, E1, and O1 substantially constitute an isosceles triangle. Likewise, the grating vectors IN, E2, and O2 substantially constitute an isosceles triangle. The sum of the grating vector IN provided for the incidence diffraction grating 2, the grating vector E1 provided for the first region 51, and the basic grating vector O1 provided for the emission diffraction grating 4 is 0. Likewise, the sum of the grating vector IN provided for the incidence diffraction grating 2, the grating vector E2 provided for the second region 52, and the basic grating vector O2 provided for the emission diffraction grating 4 is 0. This can suppress a deterioration of image quality. The image quality deteriorates as a difference increases.

Moreover, the grating vector E1 of the diffraction grating having the highest diffraction efficiency among the diffraction gratings provided for the first region 51 is provided in a different direction from the grating vector E2 of the diffraction grating having the highest diffraction efficiency among the diffraction gratings provided for the second region 52.

Referring to FIG. 1 again, the diffraction grating will be described. Light from the incidence diffraction grating 2 is diffracted through the first region 51, the second region 52, and the emission diffraction grating 4 in this order and is projected into the pupils of an observer. Alternatively, light from the incidence diffraction grating 2 is diffracted through the second region 52, the first region 51, and the emission diffraction grating 4 in this order and is projected into the pupils of the observer. In other words, the first region 51 and the second region 52 diffract light from the incidence diffraction grating 2 in mutual directions.

When light from the incidence diffraction grating 2 is diffracted through the first region 51 in a direction to the second region 52, light incident upon the second region 52 is partially projected out of the light guide plate 1. The light projected out of the light guide plate 1 is a loss. However, in front view, the first region 51 and the second region 52 each have substantially a half area as compared with those in the comparative example illustrated in FIG. 28. Thus, the amount of loss of light projected out of the light guide plate 1 through the second region 52 is reduced. This increases light use improvement. Consequently, the image quality improves.

Likewise, when light from the incidence diffraction grating 2 is diffracted through the second region 52 in a direction to the first region 51, light incident upon the first region 51 is partially projected out of the light guide plate 1. However, in front view, the first region 51 and the second region 52 each have substantially a half area as compared with those in the comparative example illustrated in FIG. 28. Thus, the amount of loss of light projected out of the light guide plate 1 through the first region 51 is reduced. This increases light use improvement. Consequently, the image quality improves.

This effect is similarly obtained also in other embodiments, which will be described later. Hence, repeated descriptions may be omitted in other embodiments.

The number of regions provided for the expansion diffraction grating 5 is not particularly limited. In the foregoing configuration example, the expansion diffraction grating 5 has the two regions. Three or more regions may be provided instead. The smaller the area where the diffraction grating having the function of projecting light out of the light guide plate 1 is formed, the smaller the amount of loss of light projected out of the light guide plate 1.

The contents described about the light guide plate according to the first embodiment of the present technique can be applied to other embodiments of the present technique unless any technical contradictions arise.

### 2. Second Embodiment (Example 2 of Light Guide Plate)

### [(1) Configuration]

A light guide plate according to an embodiment of the present technique further includes a first diffraction grating and a second diffraction grating that are at least two diffraction gratings opposed to each other with the expansion diffraction grating interposed therebetween in front view, the diffraction gratings diffracting, to the emission diffraction grating, the light diffracted by the expansion diffraction grating, wherein the pitch and the direction of the diffraction grating provided for the expansion diffraction grating may be substantially identical to the pitches and the directions of the diffraction gratings provided for the first diffraction grating and the second diffraction grating.

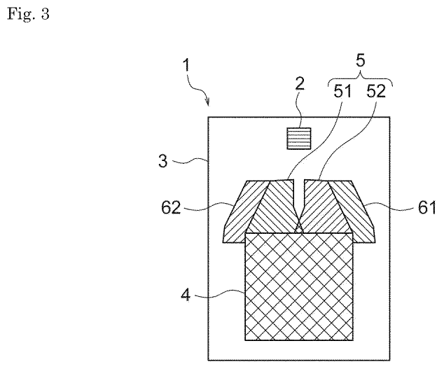

Referring to FIG. 3, a configuration example of the light guide plate according to the embodiment of the present technique will be described below. FIG. 3 is a schematic front view illustrating a configuration example of a light guide plate 1 according to the embodiment of the present technique.

As illustrated in FIG. 3, the light guide plate 1 further includes a first diffraction grating 61 and a second diffraction grating 62 that are at least two diffraction gratings opposed to each other with an expansion diffraction grating 5 interposed therebetween in front view, the diffraction gratings 61 and 62 diffracting, to an emission diffraction grating 4, the light diffracted by the expansion diffraction grating 5.

Each of the first diffraction grating 61 and the second diffraction grating 62 has a banded one-dimensional periodic structure. Thus, each of the first diffraction grating 61 and the second diffraction grating 62 can diffract light from the expansion diffraction grating 5 in a specific direction. In this configuration example, each of the first diffraction grating 61 and the second diffraction grating 62 performs diffraction substantially in the same direction as the direction of light emitted by an incidence diffraction grating 2.

The pitch and the direction of the diffraction grating for the expansion diffraction grating 5 are substantially identical to the pitches and the directions of the diffraction gratings for the first diffraction grating 61 and the second diffraction grating 62. The pitch and the direction of the diffraction grating for a first region 51 are substantially identical to the pitch and the direction of the diffraction grating for the first diffraction grating 61. The pitch and the direction of the diffraction grating for a second region 52 are substantially identical to the pitch and the direction of the diffraction grating for the second diffraction grating 62. The pitch means a periodic interval between the periodic structures of the diffraction gratings.

### [(2) Grating Vector]

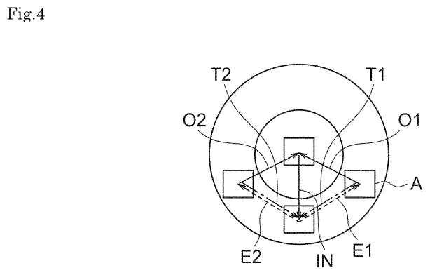

Referring to FIG. 4, a design example of the diffraction gratings will be described below. FIG. 4 shows wave number space coordinates indicating the design example of the diffraction gratings according to the embodiment of the present technique. As shown in FIG. 4, grating vectors IN, E1, E2, T1, T2, O1, and O2 and field angle areas A are indicated.

The grating vector IN indicates a grating vector provided for the incidence diffraction grating 2. The grating vector E1 indicates the grating vector of the diffraction grating having the highest diffraction efficiency among diffraction gratings provided for the first region 51. The grating vector E2 indicates the grating vector of the diffraction grating having the highest diffraction efficiency among diffraction gratings provided for the second region 52. The grating vector T1 indicates a grating vector provided for the first diffraction grating 61. The grating vector T2 indicates a grating vector provided for the second diffraction grating 62. The basic grating vectors O1 and O2 indicate basic grating vectors provided for the emission diffraction grating 4.

In this design example, the grating vectors IN, E1, and O1 substantially constitute an isosceles triangle. Likewise, the grating vectors IN, E2, and O2 substantially constitute an isosceles triangle. The sum of the grating vector IN provided for the incidence diffraction grating 2, the grating vector E1 provided for the first region 51, and the basic grating vector O1 provided for the emission diffraction grating 4 is 0. Likewise, the sum of the grating vector IN provided for the incidence diffraction grating 2, the grating vector E2 provided for the second region 52, and the basic grating vector O2 provided for the emission diffraction grating 4 is 0. This can suppress a deterioration of image quality. The image quality deteriorates as a difference increases.

Moreover, the grating vector E1 of the diffraction grating having the highest diffraction efficiency among the diffraction gratings provided for the first region 51 is provided in a different direction from the grating vector E2 of the diffraction grating having the highest diffraction efficiency among the diffraction gratings provided for the second region 52.

As described above, the pitch and the direction of the diffraction grating provided for the first region 51 are substantially identical to the pitch and the direction of the diffraction grating provided for the first diffraction grating 61. Thus, the magnitude of the grating vector E1 and the magnitude of the grating vector T1 are substantially equal to each other. However, the direction of the grating vector E1 and the direction of the grating vector T1 are opposite to each other with respect to the axis of the grating vector IN.

Likewise, the pitch and the direction of the diffraction grating for the second region 52 are substantially identical to the pitch and the direction of the diffraction grating for the second diffraction grating 62. Thus, the magnitude of the grating vector E2 and the magnitude of the grating vector T2 are substantially equal to each other. However, the direction of the grating vector E2 and the direction of the grating vector T2 are opposite to each other with respect to the axis of the grating vector IN.

### [(3) Effects]

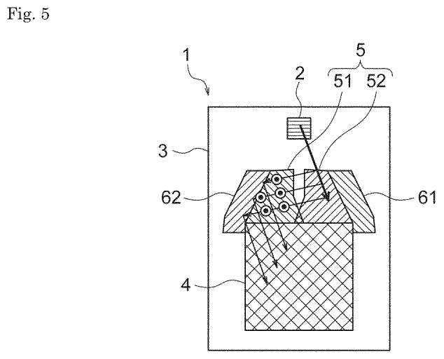

Referring to FIG. 5, the effects of the design example will be described below. FIG. 5 is a schematic front view illustrating a configuration example of the light guide plate 1 according to the embodiment of the present technique.

As illustrated in FIG. 5, light from the incidence diffraction grating 2 is diffracted through the second region 52, the second diffraction grating 62, and the emission diffraction grating 4 in this order and is projected into the pupils of an observer. Alternatively, light from the incidence diffraction grating 2 is diffracted through the first region 51, the first diffraction grating 61, and the emission diffraction grating 4 in this order and is projected into the pupils of the observer. Light from the incidence diffraction grating 2 is projected at various angles into the first region 51 or the second region 52.

When light from the incidence diffraction grating 2 is diffracted through the first region 51 in a direction to the second region 52, light incident upon the second region 52 is partially projected out of the light guide plate 1. However, in front view, the first region 51 and the second region 52 each have substantially a half area as compared with those in the comparative example illustrated in FIG. 28. Thus, the amount of loss of light projected out of the light guide plate 1 through the second region 52 is reduced. This increases light use improvement. Consequently, the image quality improves.

Furthermore, considering an angle of light projected from the light guide plate 1 into the pupils of an observer, light emitted from the incidence diffraction grating 2 in a rightward direction in FIG. 5 is preferably projected into the pupils of the observer from the left side of the emission diffraction grating 4. It is preferable that light diffracted through the second region 52 disposed on the right side in FIG. 5 is diffracted by the second diffraction grating 62 and is projected from the left side of the emission diffraction grating 4 into the pupils of the observer. At this point, the incident angle of light from the incidence diffraction grating 2 and the incident angle of light from the emission diffraction grating 4 are preferably equal to each other. As illustrated in FIG. 4, the magnitude of the grating vector E2 for the second region 52 and the magnitude of the grating vector T2 for the second diffraction grating 62 are substantially equal to each other. However, the direction of the grating vector E2 and the direction of the grating vector T2 are opposite to each other with respect to the axis of the grating vector IN. Thus, the flows of light are obtained as illustrated in FIG. 5.

As illustrated in FIG. 5, the first region 51 and the second diffraction grating 62 are preferably adjacent to each other in front view. Likewise, the second region 52 and the first diffraction grating 61 are preferably adjacent to each other in front view. The shorter the distances to the first diffraction grating 61, the first region 51, and the emission diffraction grating 4, the higher the light use improvement. The shorter the distances to the second diffraction grating 62, the second region 52, and the emission diffraction grating 4, the higher the light use improvement.

The number of diffraction gratings held by the expansion diffraction grating 5 is not particularly limited. In the foregoing configuration example, the number of diffraction gratings having the same pitch and direction as the diffraction grating for the expansion diffraction grating 5 is two (the first diffraction grating 61 and the second diffraction grating 62). Three or more diffraction gratings may be disposed instead.

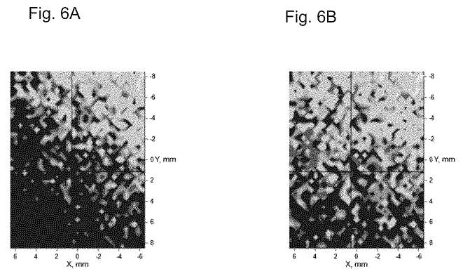

Referring to FIG. 6, the simulation results of the present technique will be described below. FIG. 6 shows light intensity distribution charts indicating simulation results on the use of the light guide plate 1 according to the embodiment of the present technique. A color close to white indicates high light intensity. FIG. 6A shows a simulation result on the use of the light guide plate according to the comparative example in FIG. 28. FIG. 6B shows a simulation result on the use of the light guide plate 1 according to the present embodiment.

As shown in FIG. 6, according to the present technique, it is understood that light emitted from the emission diffraction grating 4 has substantially uniform light intensity because the amount of loss of light from the expansion diffraction grating 5 decreases and the first diffraction grating 61 and the second diffraction grating 62 diffract light inward. Finely grained irregularities of high frequencies are caused by the number of rays in simulation.

In this simulation, the refractive index of the substrate 3 is about 2.0, the wavelength of light is about 530 nm, and the pitch of the diffraction grating is about 360 nm. The values of the refractive index of the substrate 3, the wavelength, and the pitch of the diffraction grating vary depending upon the design contents. For example, if blue light having a short wavelength is used, the pitch of the diffraction grating decreases. If red light having a long wavelength is used, the pitch of the diffraction grating increases. Moreover, the pitch of the diffraction grating decreases as the refractive index of the substrate 3 increases. The pitch varies depending upon the design of the light guide plate. For example, when the refractive index of the substrate 3 ranges from 1.4 to 2.6, a pitch having the basic grating vector in the present example is included in the range of 200 nm to 600 nm.

### [(4) Configuration of Expansion Diffraction Grating, etc.]

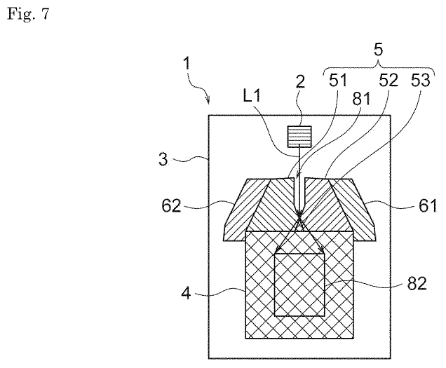

Referring to FIG. 7, the configuration of the expansion diffraction grating 5 will be described below. FIG. 7 is a schematic front view illustrating a configuration example of the light guide plate 1 according to the embodiment of the present technique.

As illustrated in FIG. 7, a clearance 81 is preferably formed at least in a part near the incidence diffraction grating 2 and between the first region 51 and the second region 52 in front view. The clearance 81 is preferably formed substantially at the center of the divergence of a pencil of light emitted from the incidence diffraction grating 2 to the expansion diffraction grating 5. The clearance 81 is preferably formed near the incidence diffraction grating 2 in front view. Thus, when a diverged pencil of light is projected from the incidence diffraction grating 2 to the expansion diffraction grating 5, a ray substantially at the center of the divergence of the pencil of light L1 is incident upon the expansion diffraction grating 5, so that the emission of light out of the light guide plate 1 as a loss can be suppressed.

Furthermore, in front view, a third region 53 is preferably formed as an overlap made by at least parts of the first region 51 and the second region 52 near the emission diffraction grating 4. The third region 53 is preferably formed substantially at the center of the divergence of a pencil of light emitted from the incidence diffraction grating 2 to the expansion diffraction grating 5. The third region 53 is preferably formed near the emission diffraction grating 4 in front view. The third region 53 preferably has a two-dimensional periodic structure. Thus, when a pencil of light is diverged and projected from the incidence diffraction grating 2 into the expansion diffraction grating 5, the ray substantially at the center of the divergence of the pencil of light L1 is incident upon the third region 53, so that the light is diverged to the outside. As a result, the light can be properly projected to pupils at any location in an eye box 82. The eye box is a size determined by a design field angle, the positions of observer's pupils with respect to the light guide plate, and the positional tolerance of the positions. In particular, if the light guide plate 1 is provided in a head-mounted display (HMD) mounted on the head of a user, the eye box is a value determined in consideration of a shift of the HMD on the head and a distance between pupils. Typically, the eye box 82 is frequently disposed in the emission diffraction grating 4 in front view.

Moreover, the shape and area of the third region 53 vary according to, for example, the size of the eye box 82, a distance between the incidence diffraction grating 2 and the emission diffraction grating 4, the path of light guided in the light guide plate 1, the characteristics of the material of the light guide plate 1, or a required wavelength or field angle range.

The first region 51 and the second diffraction grating 62 adjacent to each other in front view have different grating vector directions. Furthermore, the shape of the diffraction grating may be deformed at the interface between the first region 51 and the second diffraction grating 62 that are adjacent to each other in front view. Thus, when light is projected to the first region 51 and the second diffraction grating 62 at the same time, a wave front may be disturbed to deteriorate image quality. Likewise, the second region 52 and the first diffraction grating 61 that are adjacent to each other in front view have different grating vector directions. Furthermore, the shape of the diffraction grating may be deformed at the interface between the second region 52 and the first diffraction grating 61 that are adjacent to each other in front view. Thus, when light is projected to the second region 52 and the first diffraction grating 61 at the same time, a wave front may be disturbed to deteriorate image quality. For this reason, the first region 51 and the second diffraction grating 62 are preferably disposed on different surfaces. The second region 52 and the first diffraction grating 61 are preferably disposed on different surfaces.

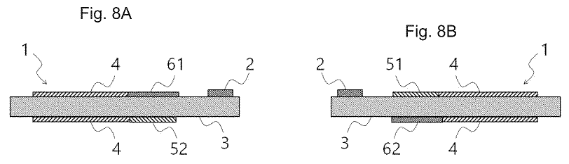

Referring to FIG. 8, this point will be described below. FIG. 8 is a schematic side view illustrating the configuration example of the light guide plate 1 according to the embodiment of the present technique. FIG. 8A is a right side view of FIG. 7. FIG. 8B is a left side view of FIG. 7.

As illustrated in FIG. 8, the first region 51 and the first diffraction grating 61 are formed on one surface of a substrate 3. The second region 52 and the second diffraction grating 62 are disposed on the other surface of the substrate 3. Thus, disturbance of a wave front can be suppressed. Consequently, the image quality can be improved.

The first region 51 and the second diffraction grating 62 that are disposed on different surfaces can overlap each other in front view, which is not illustrated. Likewise, the second region 52 and the first diffraction grating 61 that are disposed on different surfaces can overlap each other in front view.

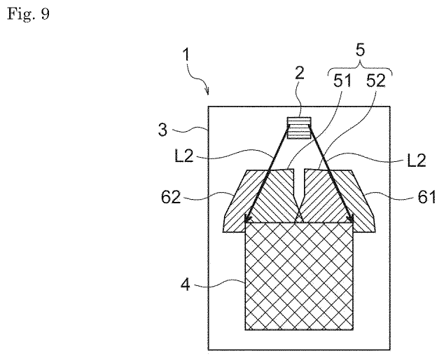

In front view, the boundary between the first region 51 and the second diffraction grating 62 is preferably adjacent to the outer side of a ray of light having the largest incident angle among rays of light from the incidence diffraction grating 2. Likewise, the boundary between the first region 51 and the second diffraction grating 62 is preferably adjacent to the outer side of a ray of light having the largest incident angle among rays of light from the incidence diffraction grating 2. Referring to FIG. 9, this point will be described below. FIG. 9 is a schematic front view illustrating a configuration example of the light guide plate 1 according to the embodiment of the present technique.

As illustrated in FIG. 9, the boundary between the first region 51 and the second diffraction grating 62 is adjacent to the outer side of a ray of light having the largest incident angle L2 among rays of light from the incidence diffraction grating 2. Thus, light diffracted by the second diffraction grating 62 is likely to be projected into the emission diffraction grating 4. Consequently, the light use efficiency improves.

Likewise, the boundary between the second region 52 and the first diffraction grating 61 is adjacent to the outer side of a ray of light having the largest incident angle L2 among rays of light from the incidence diffraction grating 2. Thus, light diffracted by the first diffraction grating 61 is likely to be projected into the emission diffraction grating 4. Consequently, the light use efficiency improves.

Each of the first diffraction grating 61 and the second diffraction grating 62 preferably has high diffraction efficiency. Thus, light diffracted by the first diffraction grating 61 and the second diffraction grating 62 is likely to be projected into the emission diffraction grating 4. Consequently, the light use efficiency improves. Diffraction to the emission diffraction grating 4 may be interrupted depending upon an incident angle from the incidence diffraction grating 2. Thus, it is preferable to design the diffraction efficiency of the first diffraction grating 61 and the second diffraction grating 62 according to the incident angle.

Means for increasing the diffraction efficiency of the first diffraction grating 61 and the second diffraction grating 62 is not particularly limited. For example, a coating layer containing a resin having a high refractive index and a metal or the like may be applied. The coating layer may be a single layer or a laminate of multiple layers. Alternatively, in order to increase the diffraction efficiency, the thickness of a remaining film between the diffraction grating and the substrate may be adjusted or the height or shape (for example, a stepped shape, a blazed shape, a trapezoidal shape, or an overhung trapezoidal shape) of the diffraction grating may be adjusted.

Moreover, in order to prevent disturbance of a wave front, a clearance may be formed between the first region 51 and the second diffraction grating 62. Likewise, a clearance may be formed between the second region 52 and the first diffraction grating 61. The clearance is preferably a distance equal to or larger than the width of a pencil of light from the incidence diffraction grating 2.

### [(5) Simulation Results]

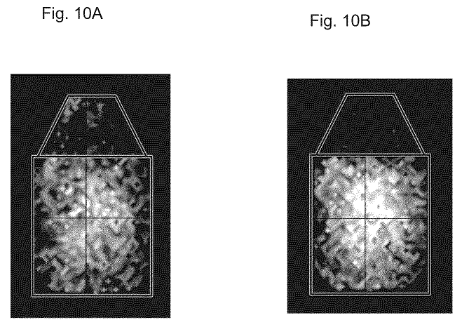

Referring to FIG. 10, the simulation results of the present technique will be described below. FIG. 10 shows light intensity distribution charts indicating simulation results on the use of the light guide plate 1 according to the embodiment of the present technique. A color close to white indicates high light intensity. FIG. 10A shows a simulation result on the use of the light guide plate according to the comparative example in FIG. 28. FIG. 10B shows a simulation result on the use of the light guide plate 1 according to the present embodiment.

As shown in FIG. 10, according to the present technique, it is understood that the amount of loss of light from the expansion diffraction grating 5 decreases.

Furthermore, it is understood that each of the first diffraction grating 61 and the second diffraction grating 62 diffracts light inward so as to increase the light intensity of light emitted by the emission diffraction grating 4. In this simulation result, the amount of loss of light is reduced by about 30%.

In this simulation, the refractive index of the substrate 3 is about 2.0, the wavelength of light is about 530 nm, and the pitch of the diffraction grating is about 360 nm. The values of the refractive index of the substrate 3, the wavelength, and the pitch of the diffraction grating vary depending upon the design contents. For example, if blue light having a short wavelength is used, the pitch of the diffraction grating decreases. If red light having a long wavelength is used, the pitch of the diffraction grating increases. Moreover, the pitch of the diffraction grating decreases as the refractive index of the substrate 3 increases.

[(6) Comparison with Conventional Art]

In the following description, the conventional art and the present technique will be compared with each other. For example, in PTL 1 (Specification of U.S. Patent Application Publication No. 2018/0210205), the three diffraction gratings are provided to guide light to an optimum position. However, light is emitted out of these diffraction gratings, so that the light may be lost.

In PTL2 (WO 2020/217044), light use efficiency is improved by providing the diffraction gratings for diffraction to the inside of the light guide plate in front view. However, as in PTL 1, light is emitted out of these diffraction gratings, so that the light may be lost.

In PTL 3 (Specification of U.S. Patent Application Publication No. 2021/0311260), a light guide plate for guiding incident light to a proper position is added to a conventional light guide plate. Unfortunately, the addition of the light guide plate causes problems such as an increase in manufacturing cost due to an increase in the number of manufacturing steps, an increase in the weight of the light guide plate, or a deterioration of a form factor due to an increase in the thickness of the light guide plate.

In contrast, in the present technique, the expansion diffraction grating 5 is divided into a plurality of regions having small areas, thereby reducing the amount of loss of light. Furthermore, each of the first diffraction grating 61 and the second diffraction grating 62 can internally diffract light diffracted by the expansion diffraction grating 5 to the outside. Thus, light is allowed to reach a region that is less likely to receive in the conventional art when the diffraction efficiency of the emission diffraction grating 4 is increased. Consequently, the light intensity of light projected into the pupils of an observer can be made substantially uniform while improving the light use efficiency. Moreover, unlike in the disclosure of PTL 3, a light guide plate for guiding incident light to a proper position is not added, so that the foregoing problem can be solved.

The contents described about the light guide plate according to the second embodiment of the present technique can be applied to other embodiments of the present technique unless any technical contradictions arise.

### 3. Third Embodiment (Example 3 of Light Guide Plate)

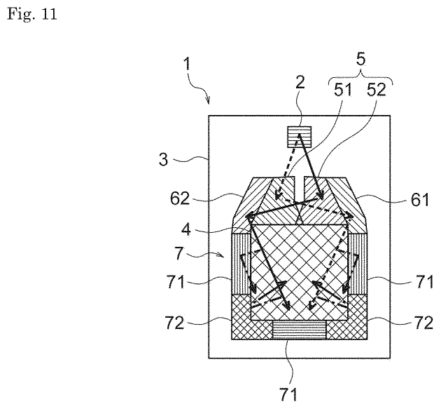

A light guide plate 1 according to an embodiment of the present technique preferably includes another return diffraction grating that diffracts light in an inward direction of an emission diffraction grating 4 in front view. Referring to FIG. 11, this point will be described below. FIG. 11 is a schematic front view illustrating a configuration example of the light guide plate 1 according to the embodiment of the present technique.

As illustrated in FIG. 11, the light guide plate 1 further includes a return diffraction grating 7 that diffracts light in an inward direction of the emission diffraction grating 4. The return diffraction grating 7 is disposed outside a region where light is incident from a substrate 3 and is disposed at outer periphery of the emission diffraction grating 4. The return diffraction grating 7 diffracts light in an inward direction of the emission diffraction grating 4, thereby improving light use efficiency.

In the return diffraction grating 7, a return diffraction grating 71 disposed on a side portion has a banded one-dimensional periodic structure. Thus, high priority is placed on the effect of diffracting light in one direction. A return diffraction grating 72 disposed at a corner has a two-dimensional periodic structure, which can diffract light in a plurality of directions.

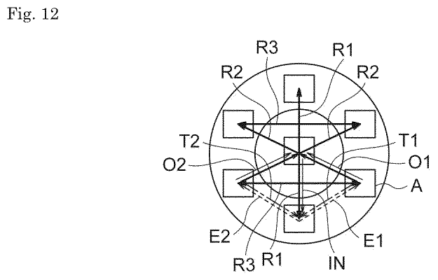

The pitch of the return diffraction grating 7 is preferably a value obtained by dividing the pitch of the emission diffraction grating 4 by 2. Hence, the magnitude of a grating vector provided for the return diffraction grating 7 is substantially two times larger than the magnitude of a basic grating vector provided for the emission diffraction grating 4. Referring to FIG. 12, this point will be described below. FIG. 12 shows wave number space coordinates indicating a design example of the diffraction gratings according to the embodiment of the present technique.

As shown in FIG. 12, grating vectors R1, R2, and R3 are indicated. The grating vectors R1, R2, and R3 indicate grating vectors provided for the return diffraction grating 7. The magnitude of the grating vector R1 is substantially two times larger than the magnitude of a grating vector IN provided for an incidence diffraction grating 2. The magnitude of the grating vector R2 is two times larger than the magnitudes of basic grating vectors O1 and O2 provided for the emission diffraction grating 4. The grating vector R3 is substantially identical to a vector connecting the initial points of the basic grating vectors O1 and O2. The return diffraction grating 7 includes such grating vectors, thereby diffracting light in an inward direction of the emission diffraction grating 4 in front view. Consequently, the light use efficiency improves.

The return diffraction grating 7 preferably has high diffraction efficiency. Thus, light diffracted by the return diffraction grating 7 is likely to be projected into the emission diffraction grating 4. Consequently, the light use efficiency improves. Means for increasing the diffraction efficiency of the return diffraction grating 7 is not particularly limited. For example, a coating layer containing a resin having a high refractive index and a metal or the like may be applied. The coating layer may be a single layer or a laminate of multiple layers. Alternatively, in order to increase the diffraction efficiency, the thickness of a remaining film between the diffraction grating and the substrate may be adjusted or the height, width, or shape of the diffraction grating may be adjusted.

The contents described about the light guide plate according to the third embodiment of the present technique can be applied to other embodiments of the present technique unless any technical contradictions arise.

### 4. Fourth Embodiment (Example 4 of Light Guide Plate)

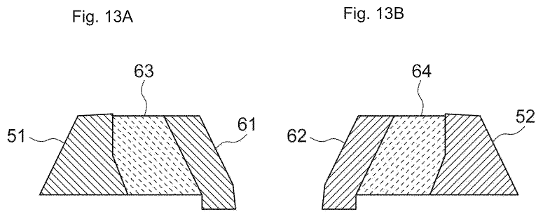

A third diffraction grating may be further provided between a first region 51 and a first diffraction grating 61. The third diffraction grating is adjacent to the first region 51 and has lower diffraction efficiency than the first region 51 at a diffraction order for emitting light out of a light guide plate 1. Referring to FIG. 13, this point will be described below. FIG. 13 is a schematic front view illustrating a configuration example of the light guide plate 1 according to an embodiment of the present technique. FIG. 13A is viewed from one surface of a substrate 3. FIG. 13B is viewed from the opposite surface.

As illustrated in FIG. 13A, the light guide plate 1 further includes a third diffraction grating 63 between the first region 51 and the first diffraction grating 61. The third diffraction grating 63 is adjacent to the first region 51. The third diffraction grating 63 has lower diffraction efficiency than the first region 51 at a diffraction order for emitting light out of the light guide plate 1. The pitch and the direction of the diffraction grating for the first region 51 are substantially identical to the pitch and the direction of the diffraction grating 63 for the third diffraction grating.

For example, in the case of a configuration not including the third diffraction grating 63, a shape may be deformed at an edge of the first region 51 (a portion as a border with the third diffraction grating 63) in manufacturing. If the area is located on a light beam path, the wave front of light incident on the area may be disturbed to deteriorate image quality. In such a case, the disturbance of a wave front can be prevented by consecutively placing similar shapes instead of forming an edge completely free of diffraction gratings. Thus, the diffraction of light by the third diffraction grating 63 can be suppressed after the light is diffracted through the first region 51. Consequently, the amount of loss of light can be reduced.

Means for reducing the diffraction efficiency of the third diffraction grating 63 is not particularly limited. In order to reduce the diffraction efficiency, for example, a shape including the height or width of the diffraction grating may be adjusted or the thickness of a remaining film between the diffraction grating and the substrate may be adjusted. Alternatively, a coating layer containing a resin having a low refractive index and a metal or the like may be applied. The coating layer may be a single layer or a laminate of multiple layers. Alternatively, the third diffraction grating 63 may be free of the diffraction grating. Specifically, a region that is adjacent to the first region 51 and has a substantially flat entry face for light may be further provided between the first region 51 and the first diffraction grating 61. The third diffraction grating 63 does not include the diffraction grating and thus is placed in the same state as a cut state, so that the shape may be easily controlled particularly at an edge in manufacturing.

Likewise, as illustrated in FIG. 13B, a fourth diffraction grating may be further provided between a second region 52 and a second diffraction grating 62. The fourth diffraction grating is adjacent to the second region 52 and has lower diffraction efficiency than the second region 52 at a diffraction order for emitting light out of the light guide plate 1. The pitch and the direction of the diffraction grating for a second region 52 are substantially identical to the pitch and the direction of the diffraction grating for the fourth diffraction grating 64.

The contents described about the light guide plate according to the fourth embodiment of the present technique can be applied to other embodiments of the present technique unless any technical contradictions arise.

### 5. Fifth Embodiment (Example 5 of Light Guide Plate)

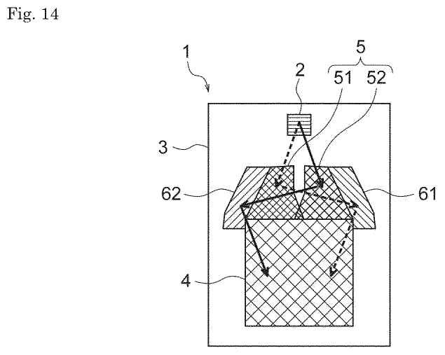

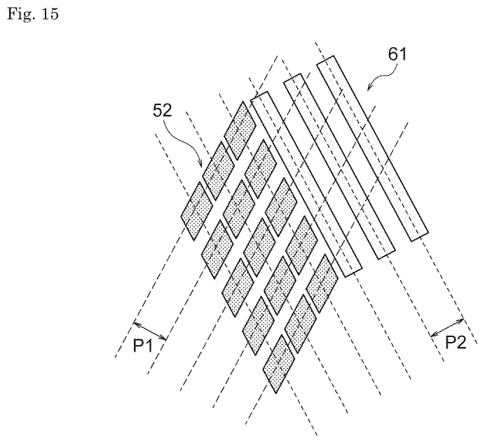

Diffraction gratings provided for an expansion diffraction grating 5 may be placed in a two-dimensional array. Referring to FIGS. 14 and 15, this configuration will be described below. FIG. 14 is a schematic front view illustrating a configuration example of a light guide plate 1 according to an embodiment of the present technique. FIG. 15 illustrates a diffraction grating configuration example around the boundary between a second region 52 and a first diffraction grating 61 according to the embodiment of the present technique.

As illustrated in FIG. 14, the diffraction gratings provided for the expansion diffraction grating 5 are placed in a two-dimensional array. Thus, the expansion diffraction grating 5 can diffract light in a plurality of directions.

As illustrated in FIG. 15, the diffraction gratings provided for the second region 52 serving as a part of the expansion diffraction grating 5 are placed in a two-dimensional array. The diffraction gratings provided for the second region 52 have the pitch of a diffraction order for the highest diffraction efficiency and a smaller pitch. Thus, the second region 52 can intensively diffract light in a specific direction as in a one-dimensional array, through the diffraction gratings are placed in a two-dimensional array.

Furthermore, the expansion diffraction grating 5 and the first diffraction grating 61 or a second diffraction grating 62 include diffraction gratings with substantially the same pitch in at least one and substantially the same direction. In addition to the pitch with the highest diffraction efficiency, the expansion diffraction grating 5 includes substantially the same pitch in substantially the same direction as the first diffraction grating 61 or the second diffraction grating 62, though the diffraction efficiency is not high in the opposite direction. This can reduce a rapid change of a grating vector. Thus, disturbance of a wave front can be suppressed.

As in the second region 52, diffraction gratings provided for the first diffraction grating 61 may be also placed in a two-dimensional array, which is not illustrated. At this point, the diffraction gratings provided for the first diffraction grating 61 have the pitch of a diffraction order for the highest diffraction efficiency and a smaller pitch. Thus, the first diffraction grating 61 can intensively diffract light in a specific direction as in a one-dimensional array, through the diffraction gratings are placed in a two-dimensional array.

The contents described about the light guide plate according to the fifth embodiment of the present technique can be applied to other embodiments of the present technique unless any technical contradictions arise.

### [6. Sixth Embodiment (Example 6 of Light Guide Plate)]

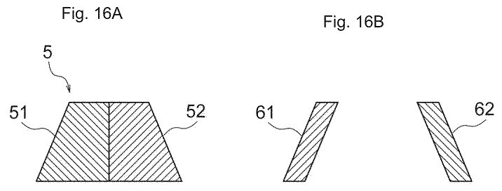

A first region 51 and a second region 52 may be disposed on one surface of a substrate 3 while a first diffraction grating 61 and a second diffraction grating 62 may be disposed on the other surface of the substrate 3. Referring to FIG. 16, this configuration will be described below. FIG. 16 schematically illustrates a configuration example of diffraction gratings according to an embodiment of the present technique. FIG. 16A illustrates the configuration example of the first region 51 and the second region 52 when viewed from one surface of the substrate 3. FIG. 16B illustrates the configuration example of the first diffraction grating 61 and the second diffraction grating 62 when viewed from the opposite surface.

As illustrated in FIG. 16A, the first region 51 and the second region 52 are disposed on one surface of the substrate 3. As illustrated in FIG. 16B, the first diffraction grating 61 and the second diffraction grating 62 are formed on the other surface of the substrate 3. In other words, the first region 51 and the second diffraction grating 62 are disposed on different surfaces. The second region 52 and the first diffraction grating 61 are disposed on different surfaces. Thus, deterioration of image quality due to disturbance of a wave front can be suppressed. Since the first region 51 and the second region 52 are disposed on the same surface, the occurrence of a shaping error at an edge can be prevented.

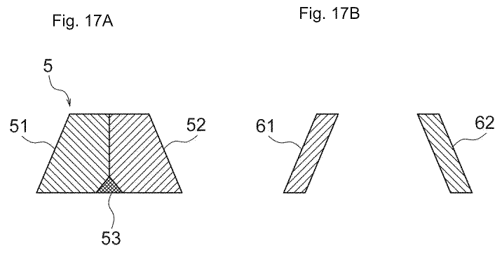

Furthermore, in front view, a third region 53 may be formed as an overlap made by at least parts of the first region 51 and the second region 52 near an emission diffraction grating 4. Referring to FIG. 17, this configuration will be described below. FIG. 17 schematically illustrates a configuration example of the diffraction gratings according to the embodiment of the present technique. FIG. 17A illustrates the configuration example of the first region 51 and the second region 52 when viewed from one surface of the substrate 3. FIG. 17B illustrates the configuration example of the first diffraction grating 61 and the second diffraction grating 62 when viewed from the opposite surface.

As illustrated in FIG. 17A, in front view, the third region 53 is formed as an overlap made by at least parts of the first region 51 and the second region 52 near the emission diffraction grating 4. The third region 53 preferably has a two-dimensional periodic structure. It is further preferable that among the pitches of diffraction gratings provided for the third region 53, the pitch of a diffraction order for the highest diffraction efficiency is substantially equal to the pitch of the first region 51 or the second region 52 or the pitches of both of the regions. The diffraction efficiency of the third region 53 preferably has a direction of the highest diffraction efficiency with respect to the direction of diffraction efficiency of the first region 51 or the second region 52 or both of the regions. Thus, when a diverged pencil of light is projected from an incidence diffraction grating 2 to an expansion diffraction grating 5, a ray substantially at the center of the divergence of the pencil of light is incident upon the third region 53, so that the light is expanded outward. Consequently, light can be properly projected to pupils at any locations in an eye box 82.

The contents described about the light guide plate according to the sixth embodiment of the present technique can be applied to other embodiments of the present technique unless any technical contradictions arise.

### 7. Seventh Embodiment (Example 7 of Light Guide Plate)

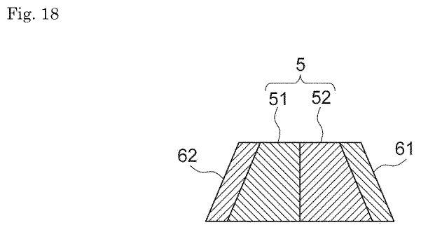

A first region 51, a second region 52, a first diffraction grating 61, and a second diffraction grating 62 may be disposed on one surface of the substrate. Referring to FIG. 18, this configuration will be described below. FIG. 18 schematically illustrates a configuration example of the diffraction gratings according to an embodiment of the present technique. FIG. 18 illustrates the configuration example when viewed from one surface of a substrate 3.

As illustrated in FIG. 18, the first region 51, the second region 52, the first diffraction grating 61, and the second diffraction grating 62 are disposed on one surface of the substrate. Thus, the first region 51, the second region 52, the first diffraction grating 61, and the second diffraction grating 62 can be shaped at the same time, thereby reducing the manufacturing cost. Since the first region 51, the second region 52, the first diffraction grating 61, and the second diffraction grating 62 are disposed on the same surface, the occurrence of a shaping error at an edge may be prevented.

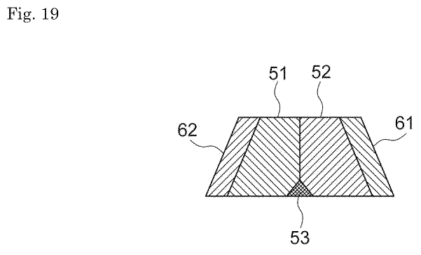

Furthermore, in front view, a third region 53 may be formed as an overlap made by at least parts of the first region 51 and the second region 52 near an emission diffraction grating 4. Referring to FIG. 19, this configuration will be described below. FIG. 19 schematically illustrates a configuration example of the diffraction gratings according to the embodiment of the present technique. FIG. 19 illustrates the configuration example when viewed from one surface of a substrate 3.

As illustrated in FIG. 19, in front view, the third region 53 is formed as an overlap made by at least parts of the first region 51 and the second region 52 near the emission diffraction grating 4. The third region 53 preferably has a two-dimensional periodic structure. It is further preferable that among the pitches of diffraction gratings provided for the third region 53, the pitch of a diffraction order for the highest diffraction efficiency is substantially equal to the pitch of the first region 51 or the second region 52 or the pitches of both of the regions. The diffraction efficiency of the third region 53 preferably has a direction of the highest diffraction efficiency with respect to the direction of diffraction efficiency of the first region 51 or the second region 52 or both of the regions. Thus, when a diverged pencil of light is projected from an incidence diffraction grating 2 to an expansion diffraction grating 5, a ray substantially at the center of the divergence of the pencil of light is incident upon the third region 53, so that the light is expanded outward. Consequently, light can be properly projected to pupils at any locations in an eye box 82.

The contents described about the light guide plate according to the seventh embodiment of the present technique can be applied to other embodiments of the present technique unless any technical contradictions arise.

### 8. Eighth Embodiment (Example 8 of Light Guide Plate)

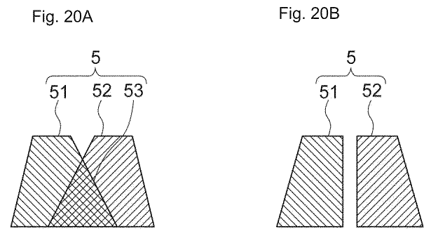

Referring to FIG. 20, another embodiment of the present technique will be described below. FIG. 20 schematically illustrates a configuration example of diffraction gratings according to the embodiment of the present technique. FIG. 20 illustrates the configuration example when viewed from one surface of a substrate 3.

In FIG. 20A, the area of a third region 53 is larger than the area of the third region 53 according to the embodiment illustrated in, for example, FIG. 19. The embodiment can be configured according to, for example, the positional relationship between the range of a field angle to be designed and an eye box.

FIG. 20B illustrates a clearance formed over a portion between a first region 51 and a second region 52. Thus, when a diverged pencil of light is projected from an incidence diffraction grating 2 to an expansion diffraction grating 5, a ray substantially at the center of the divergence of the pencil of light is incident upon the expansion diffraction grating 5, so that the emission of light out of a light guide plate 1 can be suppressed.

The contents described about the light guide plate according to the eighth embodiment of the present technique can be applied to other embodiments of the present technique unless any technical contradictions arise.

### 9. Ninth Embodiment (Example 9 of Light Guide Plate)

A first region 51, a second region 52, a first diffraction grating 61, and a second diffraction grating 62 can vary in shape according to the design of a light guide plate 1. Moreover, grating vectors in wave number space coordinates can vary in shape according to the design of the light guide plate 1.

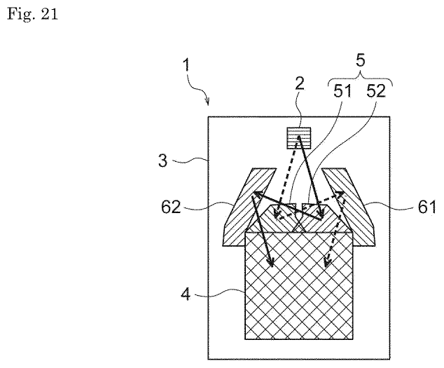

Referring to FIG. 21, another embodiment of the present technique will be described below. FIG. 21 is a schematic front view illustrating a configuration example of the light guide plate 1 according to the embodiment of the present technique.

As illustrated in FIG. 21, each of the first diffraction grating 61 and the second diffraction grating 62 is shaped to protrude toward an incidence diffraction grating 2 in front view. Thus, the first diffraction grating 61 can diffract light, which is diffracted through the first region 51 in a direction toward the incidence diffraction grating 2, to an emission diffraction grating 4. Likewise, the first diffraction grating 62 can diffract light, which is diffracted through the first region 52 in a direction toward the incidence diffraction grating 2, to the emission diffraction grating 4.

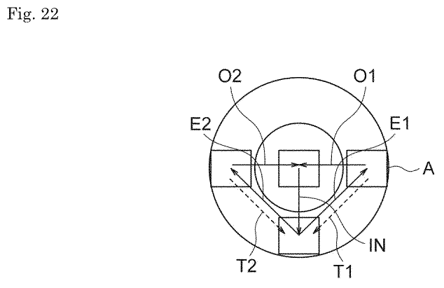

Referring to FIG. 22, a design example of the diffraction gratings will be described below. FIG. 22 shows wave number space coordinates indicating the design example of the diffraction gratings according to the embodiment of the present technique. As shown in FIG. 22, grating vectors IN, E1, E2, T1, T2, O1, and O2 and field angle areas A are indicated.

The grating vector IN indicates a grating vector provided for the incidence diffraction grating 2. The grating vector E1 indicates the grating vector of the diffraction grating having the highest diffraction efficiency among diffraction gratings provided for the first region 51. The grating vector E2 indicates the grating vector of the diffraction grating having the highest diffraction efficiency among diffraction gratings provided for the second region 52. The grating vector T1 indicates a grating vector provided for the first diffraction grating 61. The grating vector T2 indicates a grating vector provided for the second diffraction grating 62. The basic grating vectors O1 and O2 indicate basic grating vectors provided for the emission diffraction grating 4.

In this design example, the sum of the grating vector IN, the grating vector E1, and the basic grating vector O1 is 0. The grating vector IN, the grating vector E1, and the basic grating vector O1 substantially constitute a right triangle. Likewise, the sum of the grating vector IN, the grating vector E2, and the basic grating vector O2 is 0. The grating vector IN, the grating vector E2, and the basic grating vector O2 substantially constitute a right triangle. The magnitude of the grating vector E1 and the magnitude of the grating vector T1 are substantially equal to each other. The direction of the grating vector E1 and the direction of the grating vector T1 are opposite to each other with respect to the axis of the grating vector IN. The magnitude of the grating vector E2 and the magnitude of the grating vector T2 are substantially equal to each other. The direction of the grating vector E2 and the direction of the grating vector T2 are opposite to each other with respect to the axis of the grating vector IN.

The contents described about the light guide plate according to the ninth embodiment of the present technique can be applied to other embodiments of the present technique unless any technical contradictions arise.

### 10. Tenth Embodiment (Example 10 of Light Guide Plate)

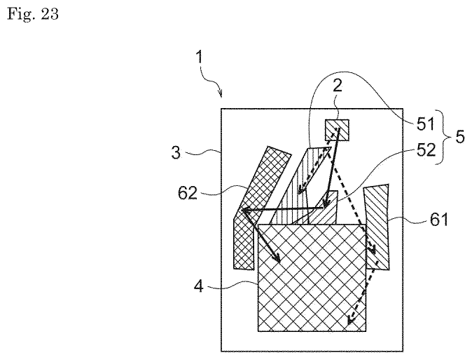

Referring to FIG. 23, another embodiment of the present technique will be described below. FIG. 23 is a schematic front view illustrating a configuration example of a light guide plate 1 according to the embodiment of the present technique.

As illustrated in FIG. 23, each of a first region 51 and a second diffraction grating 62 is shaped to protrude toward an incidence diffraction grating 2 in front view. Thus, the first region 51 can diffract part of light from the incidence diffraction grating 2 to a first diffraction grating 61. The first diffraction grating 61 can diffract light from the first region 51 to an emission diffraction grating 4. The second diffraction grating 62 can diffract light from a second region 52 to the emission diffraction grating 4. Each of the first diffraction grating 61 and the second diffraction grating 62 may include a two-dimensional diffraction grating if light can be diffracted to the emission diffraction grating 4.

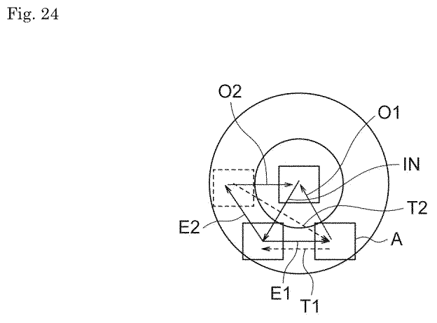

Referring to FIG. 24, a design example of the diffraction gratings will be described below. FIG. 24 shows wave number space coordinates indicating the design example of the diffraction gratings according to the embodiment of the present technique. As shown in FIG. 24, grating vectors IN, E1, E2, T1, T2, O1, and O2 and field angle areas A are indicated.

The grating vector IN indicates a grating vector provided for the incidence diffraction grating 2. The grating vector E1 indicates the grating vector of the diffraction grating having the highest diffraction efficiency among diffraction gratings provided for the first region 51. The grating vector E2 indicates the grating vector of the diffraction grating having the highest diffraction efficiency among diffraction gratings provided for the second region 52. The grating vector T1 indicates a grating vector provided for the first diffraction grating 61. The grating vector T2 indicates a grating vector provided for the second diffraction grating 62. The basic grating vectors O1 and O2 indicate basic grating vectors provided for the emission diffraction grating 4.

In this design example, the sum of the grating vector IN, the grating vector E1, and the basic grating vector O1 is 0. Likewise, the sum of the grating vector IN, the grating vector E2, and the basic grating vector O2 is 0. The magnitude of the grating vector E1 and the magnitude of the grating vector T1 are substantially equal to each other. The direction of the grating vector E1 and the direction of the grating vector T1 are opposite to each other with respect to the axis of the grating vector IN. The grating vector T2 is a vector connecting the terminal point of the grating vector E1 and the terminal point of the grating vector E2. In this design example, the terminal point of the grating vector E2 serves as the initial point of the grating vector T2 while the terminal point of the grating vector E1 serves as the initial point of the grating vector T2.

The contents described about the light guide plate according to the tenth embodiment of the present technique can be applied to other embodiments of the present technique unless any technical contradictions arise.

### 11. Eleventh Embodiment (Example 11 of Light Guide Plate)

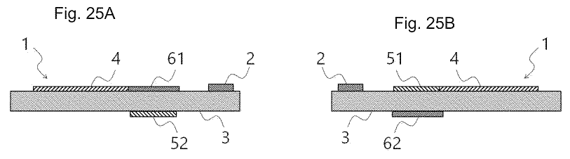

An emission diffraction grating 4 may be disposed on one or both surfaces of a light guide plate 1. Referring to FIG. 25, this configuration will be described below. FIG. 25 is a schematic side cross-sectional view illustrating a configuration example of the light guide plate 1 according to an embodiment of the present technique. FIG. 25A is a right side view of FIG. 3. FIG. 25B is a left side view of FIG. 3.

As illustrated in FIG. 25, the emission diffraction grating 4 may be disposed only on one surface of the light guide plate 1. Thus, the manufacturing process is simplified and the manufacturing cost is reduced.

As illustrated in FIG. 8, the emission diffraction grating 4 may be disposed on both surfaces of the light guide plate 1. This further increases the degree of freedom in design. Consequently, the light use efficiency can be increased and the brightness distribution can be improved. For example, the emission diffraction grating 4 disposed on one surface can control the direction that guides light in the light guide plate 1, and the emission diffraction grating 4 disposed on the other surface can project light into the pupils of an observer.

The positions where the incidence diffraction grating 2 and the emission diffraction grating 4 are disposed are not limited thereto. The incidence diffraction grating 2 and the emission diffraction grating 4 may be disposed on the same surface or may be disposed on different surfaces. The positions of the diffraction gratings vary depending upon which one of a transmission grating or a reflection grating is used. Moreover, the incidence diffraction grating 2 may be disposed on one or both surfaces of the light guide plate 1.

The contents described about the light guide plate according to the eleventh embodiment of the present technique can be applied to other embodiments of the present technique unless any technical contradictions arise.

### 12. Twelfth Embodiment (Example 12 of Light Guide Plate)

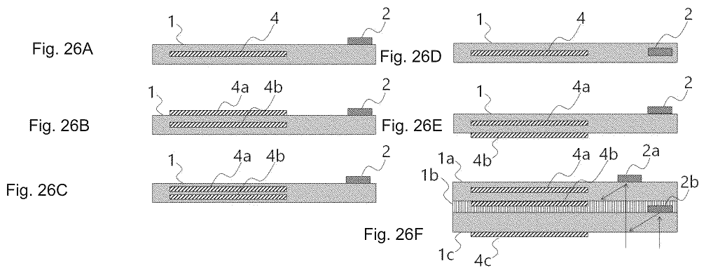

An emission diffraction grating 4 may be disposed at the same position or a different position with respect to an incidence diffraction grating 2 in the thickness direction of a light guide plate 1. The light guide plate 1 may include one or more incidence diffraction gratings 2 and one or more emission diffraction gratings 4. Referring to FIG. 26, this configuration will be described below. FIG. 26 is a schematic side cross-sectional view illustrating a configuration example of the light guide plate 1 according to an embodiment of the present technique.

As shown in FIG. 26A, the emission diffraction grating 4 may be disposed on a different surface from the incidence diffraction grating 2. In this configuration example, the emission diffraction grating 4 is disposed in the light guide plate 1. The light guide plate 1 can project monochromatic light having a single wavelength and multicolored light having different wavelengths to the pupils of an observer.

As illustrated in FIGS. 26B, 26C, and 26E, the light guide plate 1 may include the single incidence diffraction grating 2 and a plurality of emission diffraction gratings 4a and 4b. In the configuration example illustrated in FIG. 26B, the incidence diffraction grating 2 and the emission diffraction grating 4a are disposed on the same surface and are disposed on a surface of the light guide plate 1. The emission diffraction grating 4b is disposed in the light guide plate 1. In the configuration example illustrated in FIG. 26C, the emission diffraction gratings 4a and 4b are disposed in the light guide plate 1. In the configuration example illustrated in FIG. 26E, the emission diffraction grating 4a is disposed in the light guide plate 1 and the emission diffraction grating 4b is disposed on a surface of the light guide plate 1. The light guide plate 1 can project monochromatic light having a single wavelength and multicolored light having different wavelengths to the pupils of an observer.

In the configuration example illustrated in FIG. 26D, the incidence diffraction grating 2 and the emission diffraction grating 4 are disposed in the light guide plate 1. The incidence diffraction grating 2 and the emission diffraction grating 4 may be located at the same position or different positions in the thickness direction of the light guide plate 1. The light guide plate 1 can project monochromatic light having a single wavelength and multicolored light having different wavelengths to the pupils of an observer.

As illustrated in FIG. 26F, the light guide plate 1 may include a plurality of incidence diffraction gratings 2a and 2b and a plurality of emission diffraction gratings 4a, 4b, and 4c. Alternatively, a plurality of light guide plates 1 may be provided. In this configuration example, the incidence diffraction grating 2a is disposed on a surface of the light guide plate 1a and the emission diffraction grating 4a is disposed in the light guide plate 1a. In this configuration example, the emission diffraction grating 4b and the incidence diffraction grating 2b are disposed in the light guide plate 1b. The emission diffraction grating 4c is disposed on a surface of the light guide plate 1c. The light guide plates 1a, 1b, and 1c are disposed and stacked in this order. For example, the light guide plate 1a and 1c can contain a material having a high refractive index and the light guide plate 1b can contain a material having a low refractive index. According to this configuration example, the light guide plate 1 can project multicolored light having different wavelengths to the pupils of an observer. Consequently, coloring and an increased field angle can be obtained. The incidence diffraction gratings 2a and 2b may be located at the same position or different positions in the longitudinal direction of the light guide plate 1. The incidence diffraction gratings 2a and 2b located at different positions allow multicolored light having different wavelengths to be projected at different positions. This can reduce the occurrence of crosstalk.

As described above, the emission diffraction grating 4 may be disposed on a surface of the light guide plate 1 or may be disposed at various positions in the thickness direction of the light guide plate 1.

The positions of the incidence diffraction gratings 2 and the emission diffraction gratings 4, the number of light guide plates 1, the number of incidence diffraction gratings 2, and the number of emission diffraction gratings 4 are disposed are not limited to those of the foregoing configuration examples. The foregoing configuration examples may be combined.

The contents described about the light guide plate according to the twelfth embodiment of the present technique can be applied to other embodiments of the present technique unless any technical contradictions arise.

### 13. Thirteenth Embodiment (Example of Image Display Device)

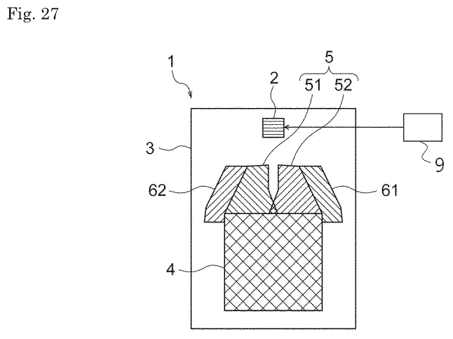

The present technique provides an image display device including the light guide plate according to the first to twelfth embodiments and an image forming unit that projects image light onto the light guide plate. Referring to FIG. 27, this configuration will be described below. FIG. 27 is a block diagram illustrating a configuration example of an image display device 10 according to an embodiment of the present technique. As illustrated in FIG. 27, the image display device 10 according to the embodiment of the present technique includes the light guide plate 1 and an image forming unit 9 that projects image light onto the light guide plate 1.

The image forming unit 9 forms image light. The image forming unit 9 allows use of a micro panel in order to produce video in the image forming unit 9. The micro panel may be, for example, a spontaneous light-emitting panel such as a micro LED or a micro OLED. An LED (Light Emitting Diode) light source or an LD (Laser Diode) light source or the like may be used in combination with an illumination optical system by using a reflection or a transmission liquid crystal.

Image light projected from the image forming unit 9 is transformed into substantially parallel rays through, for example, a projector lens (not illustrated), is condensed by the incidence diffraction grating 2, and is projected into the light guide plate 1. The incidence diffraction grating 2 may be disposed near the image forming unit 9 or on the opposite side to the image forming unit 9.

The image display device 10 may be a head-mounted display (HMD) that is mounted on the head of a user. Alternatively, the image display device 10 may be disposed as an infrastructure at a predetermined site.

The contents described about the image display device according to the thirteenth embodiment of the present technique can be applied to other embodiments of the present technique unless any technical contradictions arise.

Note that the embodiments of the present technique are not limited to the foregoing embodiments and various modifications can be made without departing from the gist of the present technique.

The present technique can also be configured as follows:

[1]

A light guide plate including: an incidence diffraction grating that diffracts incident light into a light guide plate;
a substrate that internally and totally reflects the light diffracted into the light guide plate by the incidence diffraction grating and guides the light;
an expansion diffraction grating that diffracts and expands the light guided by the substrate; and
an emission diffraction grating that diffracts the light diffracted by the expansion diffraction grating and projects the light into the pupils of an observer, wherein the expansion diffraction grating has at least two regions that are a first region and a second region in front view,
the sum of a grating vector provided for the incidence diffraction grating, a grating vector provided for the expansion diffraction grating, and a basic grating vector provided for the emission diffraction grating is 0, and
the grating vector of the diffraction grating having the highest diffraction efficiency among diffraction gratings provided for the first region is provided in a different direction from the grating vector of the diffraction grating having the highest diffraction efficiency among diffraction gratings provided for the second region.
   [2]

The light guide plate according to [1], further including a first diffraction grating and a second diffraction grating that are at least two diffraction gratings opposed to each other with the expansion diffraction grating interposed therebetween in front view, the diffraction gratings diffracting, to the emission diffraction grating, the light diffracted by the expansion diffraction grating,
wherein the pitch and the direction of the diffraction grating provided for the expansion diffraction grating are substantially identical to the pitches and the directions of the diffraction gratings provided for the first diffraction grating and the second diffraction grating.
   [3]

The light guide plate according to [2], wherein the first region and the second diffraction grating are adjacent to each other in front view, and
the second region and the first diffraction grating are adjacent to each other in front view.
   [4]

The light guide plate according to [2] or [3], wherein the first region and the first diffraction grating are disposed on one surface of the substrate, and
the second region and the second diffraction grating are disposed on the other surface of the substrate.
   [5]

The light guide plate according to any one of [2] to [4], wherein the first region and the second region are disposed on one surface of the substrate, and
the first diffraction grating and the second diffraction grating are disposed on the other surface of the substrate.
   [6]

The light guide plate according to any one of [2] to [5], wherein the first region, the second region, the first diffraction grating, and the second diffraction grating are disposed on one surface of the substrate.

[7]

The light guide plate according to any one of [1] to [6], wherein in front view, a clearance is formed at least in a part of the incidence diffraction grating between the first region and the second region, and
the clearance is formed substantially at the center of the divergence of a pencil of light emitted from the incidence diffraction grating to the expansion diffraction grating.
   [8]

The light guide plate according to any one of [1] to [7], wherein in front view, a third region is formed to overlap with at least parts of the first region and the second region at the emission diffraction grating side, and
the third region is formed substantially at the center of the divergence of a pencil of light emitted from the incidence diffraction grating to the expansion diffraction grating.
   [9]

The light guide plate according to [8], wherein the third region has a two-dimensional periodic structure.

[10]

The light guide plate according to any one of [1] to [9], further including a return diffraction grating that diffracts the light in an inward direction of the emission diffraction grating,
wherein the return diffraction grating is disposed outside a region where light is incident from the substrate and is disposed at outer periphery of the emission diffraction grating.
   [11]

The light guide plate according to [10], wherein the size of a grating vector provided for the return diffraction grating is substantially twice the size of the basic grating vector.

[12]

The light guide plate according to [10] or [11], wherein the grating vector provided for the return diffraction grating is substantially identical to a vector connecting the initial points of the basic grating vectors.

[13]

The light guide plate according to any one of [10] to [12], wherein the return diffraction grating has a one-dimensional periodic structure.

[14]

The light guide plate according to any one of [10] to [13], wherein the return diffraction grating has a two-dimensional periodic structure.

[15]

The light guide plate according to any one of [2] to [14], further including a third diffraction grating between the first region and the first diffraction grating, the third diffraction grating being adjacent to the first region and having lower diffraction efficiency than the first region at a diffraction order for emitting light out of the light guide plate,
wherein the pitch and the direction of the diffraction grating provided for the first region are substantially identical to the pitch and the direction of a diffraction grating provided for the third diffraction grating.
   [16]

The light guide plate according to any one of [2] to [14], further including a region that is adjacent to the first region and has a substantially flat entry face for the light between the first region and the first diffraction grating.

[17]

The light guide plate according to any one of [12] to [16], wherein diffraction gratings provided for the expansion diffraction grating are placed in a two-dimensional array, and
among the pitches of the diffraction gratings provided for the expansion diffraction grating, the pitch of a diffraction order for the highest diffraction efficiency is substantially equal to the pitch of the first diffraction grating or the second diffraction grating.
   [18]

The light guide plate according to any one of [2] to [17], wherein the grating vector provided for the first diffraction grating is a vector connecting the terminal point of the grating vector of the diffraction grating having the highest diffraction efficiency among diffraction gratings provided for the first region and the terminal point of the grating vector of the diffraction grating having the highest diffraction efficiency among diffraction gratings provided for the second region.

[19]

The light guide plate according to any one of [1] to [18], wherein the emission diffraction grating is disposed at the same position or a different position with respect to the incidence diffraction grating in the thickness direction of the light guide plate.

The light guide plate according to any one of [1] to [18], wherein the light guide plate includes: the one or more incidence diffraction gratings, and the one or more emission diffraction gratings.

[21]

An image display device including: the light guide plate according to any one of [1] to [20]; and
an image forming unit that projects image light onto the light guide plate.

### REFERENCE SIGNS LIST

1 Light guide plate
2 Incidence diffraction grating
3 Substrate
4 Emission diffraction grating
5 Expansion diffraction grating
51 First region
52 Second region
53 Third region
61 First diffraction grating
62 Second diffraction grating
63 Third diffraction grating
64 Fourth diffraction grating
7 Return diffraction grating
9 Image forming unit
10 Image display device
IN, E1, E2, O1, O2, T1, T2 Grating vector

1. A light guide plate comprising: an incidence diffraction grating that diffracts incident light into a light guide plate;
a substrate that internally and totally reflects the light diffracted into the light guide plate by the incidence diffraction grating and guides the light;
an expansion diffraction grating that diffracts and expands the light guided by the substrate; and
an emission diffraction grating that diffracts the light diffracted by the expansion diffraction grating and projects the light into pupils of an observer, wherein the expansion diffraction grating has at least two regions that are a first region and a second region in front view,
a sum of a grating vector provided for the incidence diffraction grating, a grating vector provided for the expansion diffraction grating, and a basic grating vector provided for the emission diffraction grating is 0, and
the grating vector of the diffraction grating having the highest diffraction efficiency among diffraction gratings provided for the first region is provided in a different direction from the grating vector of the diffraction grating having the highest diffraction efficiency among diffraction gratings provided for the second region.

2. The light guide plate according to claim 1, further comprising a first diffraction grating and a second diffraction grating that are at least two diffraction gratings opposed to each other with the expansion diffraction grating interposed therebetween in front view, the diffraction gratings diffracting, to the emission diffraction grating, the light diffracted by the expansion diffraction grating, wherein a pitch and a direction of the diffraction grating provided for the expansion diffraction grating are substantially identical to pitches and directions of the diffraction gratings provided for the first diffraction grating and the second diffraction grating.

3. The light guide plate according to claim 2, wherein the first region and the second diffraction grating are adjacent to each other in front view, and
the second region and the first diffraction grating are adjacent to each other in front view.

4. The light guide plate according to claim 2, wherein the first region and the first diffraction grating are disposed on one surface of the substrate, and
the second region and the second diffraction grating are disposed on the other surface of the substrate.

5. The light guide plate according to claim 2, wherein the first region and the second region are disposed on one surface of the substrate, and
the first diffraction grating and the second diffraction grating are disposed on the other surface of the substrate.

6. The light guide plate according to claim 2, wherein the first region, the second region, the first diffraction grating, and the second diffraction grating are disposed on one surface of the substrate.

7. The light guide plate according to claim 1, wherein in front view, a clearance is formed at least in a part of the incidence diffraction grating between the first region and the second region, and the clearance is formed substantially at a center of divergence of a pencil of light emitted from the incidence diffraction grating to the expansion diffraction grating.

8. The light guide plate according to claim 1, wherein in front view, a third region is formed to overlap with at least parts of the first region and the second region at the emission diffraction grating side, and
the third region is formed substantially at a center of divergence of a pencil of light emitted from the incidence diffraction grating to the expansion diffraction grating.

9. The light guide plate according to claim 8, wherein the third region has a two-dimensional periodic structure.

10. The light guide plate according to claim 1, further comprising a return diffraction grating that diffracts the light in an inward direction of the emission diffraction grating,
wherein the return diffraction grating is disposed outside a region where light is incident from the substrate and is disposed at outer periphery of the emission diffraction grating.

11. The light guide plate according to claim 10, wherein the size of a grating vector provided for the return diffraction grating is substantially twice the size of the basic grating vector.

12. The light guide plate according to claim 10, wherein the grating vector provided for the return diffraction grating is substantially identical to a vector connecting initial points of the basic grating vectors.

13. The light guide plate according to claim 10, wherein the return diffraction grating has a one-dimensional or two-dimensional periodic structure.

14. The light guide plate according to claim 2, further comprising a third diffraction grating between the first region and the first diffraction grating, the third diffraction grating being adjacent to the first region and having lower diffraction efficiency than the first region at a diffraction order for emitting light out of the light guide plate,
wherein a pitch and a direction of the diffraction grating provided for the first region are substantially identical to a pitch and a direction of a diffraction grating provided for the third diffraction grating.

15. The light guide plate according to claim 2, further comprising a region that is adjacent to the first region and has a substantially flat entry face for the light between the first region and the first diffraction grating.

16. The light guide plate according to claim 2, wherein diffraction gratings provided for the expansion diffraction grating are placed in a two-dimensional array, and among pitches of the diffraction gratings provided for the expansion diffraction grating, a pitch of a diffraction order for the highest diffraction efficiency is substantially equal to a pitch of the first diffraction grating or the second diffraction grating.

17. The light guide plate according to claim 2, wherein the grating vector provided for the first diffraction grating is a vector connecting a terminal point of the grating vector of the diffraction grating having the highest diffraction efficiency among diffraction gratings provided for the first region and a terminal point of the grating vector of the diffraction grating having the highest diffraction efficiency among diffraction gratings provided for the second region.

18. The light guide plate according to claim 1, wherein the emission diffraction grating is disposed at the same position or a different position with respect to the incidence diffraction grating in a thickness direction of the light guide plate.

19. The light guide plate according to claim 1, wherein the light guide plate includes:
the one or more incidence diffraction gratings, and
the one or more emission diffraction gratings.

20. An image display device comprising: the light guide plate according to claim 1; and
an image forming unit that projects image light onto the light guide plate.
